(19) United States
(12) Patent Application Publication
(10) Pub. No.: US 2014/0101298 A1
(43) Pub. Date: Apr. 10, 2014

(54) SERVICE LEVEL AGREEMENTS FOR A CONFIGURABLE DISTRIBUTED STORAGE SYSTEM

(71) Applicant: MICROSOFT CORPORATION, Redmong, WA (US)

(72) Inventors: Dharma Shukla, Sammamish, WA (US); Elisa M. Flasko, Duval, WA (US); Karthik Raman, Issaquah, WA (US); Shireesh K. Thota, Issaquah, WA (US)

(73) Assignee: MICROSOFT CORPORATION, Redmond, WA (US)

(21) Appl. No.: 13/645,512

(22) Filed: Oct. 5, 2012

(51) Int. Cl. G06F 15/173

(52) U.S. Cl. 709/223

(57) ABSTRACT

A service level agreement can be generated based on a data store configuration. In one instance, the configuration can be specified in terms of a data value such as high, medium, and low value, for example. In another instance, a workload configuration can be specified comprising a replica set and consistency level, among other things. More particularly, the service level agreement can include guarantees regarding one or more of consistency, availability, latency, or fault tolerance, among others, as a function of a data value or workload configuration. Further, operation of a service associated with a service level agreement can be monitored to determine satisfaction or violation of guarantees, and provide real time feedback.

### BACKGROUND

A service level agreement (SLA) is an agreement between a client and a service provider that defines a level of service to be delivered by the service provider to the client. SLAs conventionally revolve around performance and availability. Performance metrics that form part of SLAs can include response time, volume (e.g., amount of data transferred, number or transactions), and rate of processing. Typically expressed as a percentage of time, availability (also called uptime) refers to the ability to use a service. For example, the service could be available ninety-nine percent of the time, or more colloquially, the availability can be termed two nines.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to service level agreements (SLAs) for a configurable distributed storage system. Service level agreements are comprised of guarantees generated based on a configuration of a data store. In accordance with aspects of this disclosure, a configuration can be specified in terms of a value of data or a workload. For example, guarantees can be generated based on specification of high, medium, or low value data. Alternatively, guarantees can be generated as a function of workload configuration specifying a replica set, a consistency level, and a cluster size, for instance. In addition, a staleness metric can be specified and utilized in generation of guarantees, and conditional guarantees can be generated. Still further yet, operation of a system or service associated with a service level agreement can be monitored to identify satisfaction or violation of guarantees. Such information can be fed back in real time to clients for review and utilized to generate invoices.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a service-level-agreement system.

FIG. 2 is a block diagram of an exemplary data storage system.

FIG. 3 is a flow chart diagram of a method of service level agreement generation based on data value.

FIG. 4 is a flow chart diagram of a method of service level agreement generation based on workload.

FIG. 5 is a flow chart diagram of a monitoring method.

FIG. 6 is a schematic block diagram illustrating a suitable operating environment for aspects of the subject disclosure.

### DETAILED DESCRIPTION

Details below are generally directed toward service level agreement (SLA) generation based on a data storage configuration. SLA guarantees concerning availability, consistency, latency, or fault tolerance, among others, can be determined as a function of a configuration. Design of distributed systems, such as a distributed storage system, involves making many tradeoffs. However, potentially thousands of tradeoffs can be collapsed into a select few to facilitate configuration. For example, configuration can be specified in terms of a replica set, a consistency level, and a cluster size, which can further be reduced into specification of a different kind of data such as high, medium, and low value. SLA guarantees thus can be made based on a configuration specified in terms of a value of data or a more complex workload, for instance. Further, a staleness metric can drive guarantee generation, and conditional, or ranked, guarantees can be provided. Still further, operation of a system or service can be monitored to determine satisfaction or violation of SLA guarantees. Satisfaction and/or violation of guarantees can be provides as feedback to clients in real time, for instance through a user interface dashboard. Additionally, SLA invoices can account for violations of guarantees.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

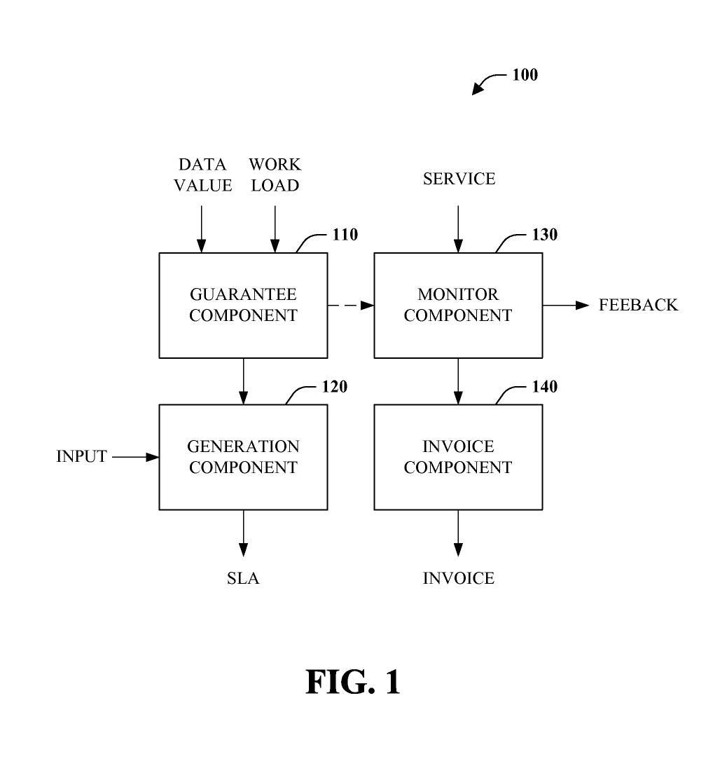

Referring initially to FIG. 1, a service-level-agreement (SLA) system 100 is illustrated. The SLA system 100 includes a guarantee component 110 configured to provide one or more SLA guarantees pertaining to availability, consistency, or latency, among other things, of a service. A guarantee is formal promise or assurance certain conditions will be fulfilled. While efforts are taken to ensure a guarantee, a guarantee is not absolute and may be violated. A guarantee can be generated as a function of a configurable data store configuration. In other words, rather than specifying one or more guarantees and generating a data store in accordance therewith, a data store is configured and one or more guarantees are generated based on the configuration. Once initially configured, however, adjustments can be made to the guarantees, which can trigger reconfiguration of the data store based thereon.

Moreover, a data store configuration can be specified and one or more guarantees can be produced based on either a value of data or a workload. The value of data is a class of data indicative of particular value to a data store customer. For example, the value of data can be specified in terms of high, medium, or low value classifications. A workload can be specified in terms of a replication policy, consistency policy, and a cluster size. Alternatively, a workload can be specified in terms of cluster size, replica set “N,” write quorum “W,” read quorum “R,” and consistency level capturing availability, consistency, and latency tradeoffs. Accordingly, novice users can configure a data store and thus an SLA based solely on the value of data, while experienced users can configure a data store and thus an SLA by manipulating finer grained parameters.

Relationships exist between replica set “N,” write quorum “W,” read quorum “R,” and consistency level, among others that enable guarantees to be determined for at least durability, availability, consistency, and latency. For example, impact to availability can be determined as a function of changes to “N” and/or “W.” Accordingly, guarantees can be generated for availability, consistency, and latency, among others based on a configuration. Specification of value of data provides three predefined configurations for high, medium, and low values. Workload is a custom configuration specified in terms various configuration parameters (e.g., “N,” “W,” “R” . . . ), which enables configurations between, above, and below those associated with high, medium, and low values.

The SLA system 100 also includes generation component 120 configured to generate an SLA. SLAs are formal agreements that define a level of service a service provider agrees to provide to a client and at what cost. An SLA can include various parts and boilerplate language as well as an associated cost model. The generation component 120 can be configured to automatically generate theses portions and include guarantees received, retrieved, or otherwise obtained or acquired from the guarantee component 110. Accordingly, the generation component 120 can automatically generate an SLA. Further, the SLA can be termed configurable since it is based on a specific data store configuration and it can subsequently be adjusted, if desired.

The generation component 120 can be configured to work with or without human intervention. In one instance, the generation component can automatically construct an SLA from start to finish. In another instance, the generation component 120 can produce a draft SLA. A human could then review the draft and make changes where desired to produce a final agreement. Alternatively, the generation component 120 can be configured as a tool to facilitate construction of an SLA by a human, by example by automating portions and/or making suggestions. Further, the generation component 120 could be bypassed such that a human can manually specify the SLA with guarantees provided by the guarantee component 110.

Monitor component 130 also forms part of the SLA system 100. The monitor component 130 is configured to monitor service operation in view of guarantees made by an SLA. The monitor component 130 can acquire guarantees determined by the guarantee component 110. Subsequently, the monitor component 130 can compare the guarantees to service operation including client interaction therewith and determine which, if any, guarantees have been satisfied and/or violated. In one instance, monitoring can be on a transactional basis. For example, upon submission of a write operation to the service a determination can be made as to whether the operation satisfied a consistency or latency guarantee. The monitor component 130 can also provide real time, or substantially real time, feedback regarding guarantees. For example, the feedback can be presented on a user interface dashboard. Accordingly, users can view performance and observe patterns in real time rather that at the end of a monthly billing cycle, for instance. This provides an opportunity to adjust configuration of the service where desired.

In accordance with one aspect of the subject invention, configurations can be specified in a ranked, or conditional, manner resulting in conditional guarantees, and thus conditional SLAs. By way of example, it can be indicated that certain levels of consistency are preferred such as strong over session over eventual. More specifically, it can be noted if strong consistency can be provided within a time period, such thirty milliseconds, that is preferred. Otherwise, session consistency within thirty milliseconds is acceptable, and if session consistency cannot be provided, eventual consistency within thirty milliseconds is satisfactory.

Real time feedback can be quite helpful in the case of ranked or conditional guarantees. For example, from such feedback it might be observed that the service is typically providing a less desirable consistency level such as eventual, for example. As a result, developer may choose to alter the service configuration to attempt to acquire a higher level of consistency such as strong consistency. In this case, there was not a violation of a guarantee but simply an undesirable result. It is, however, possible that one or more violations of guarantees revealed in the feedback could also result configuration adjustment.

The SLA system 100 also includes an invoice component 140 configured to generate a client invoice. The invoice includes charges based on a cost model associated with various guarantees of an SLA. Furthermore, the invoice component 140 can receive, retrieve, or otherwise obtain or acquire information captured by the monitor component 130 regarding satisfaction and/or violation of SLA guarantees. Such information can be included in an itemized or summarized form in the invoice and optionally utilized to compute appropriate charges in the case of a conditional guarantee or guarantee violation. For example, where a guarantee is with respect to three different consistency levels, charges can be based on the actual level of consistency provided. Further, if a guarantee is violated a client need not be charged, or the client can be credited an amount for failure to meet the guaranteed level of service.

As described briefly above, conditions can be specified and captured as guarantees in an SLA. Conditions can be expressed in terms of data value or tradeoffs such as availability, consistency, and latency. For example, a condition can specify strong consistency under so many milliseconds of latency. Another condition can specify consistent reads with five nine availability, for instance. In accordance with one embodiment, conditions can be input to the generation component. Alternatively, conditions can form part of a configuration associated with a workload or data value.

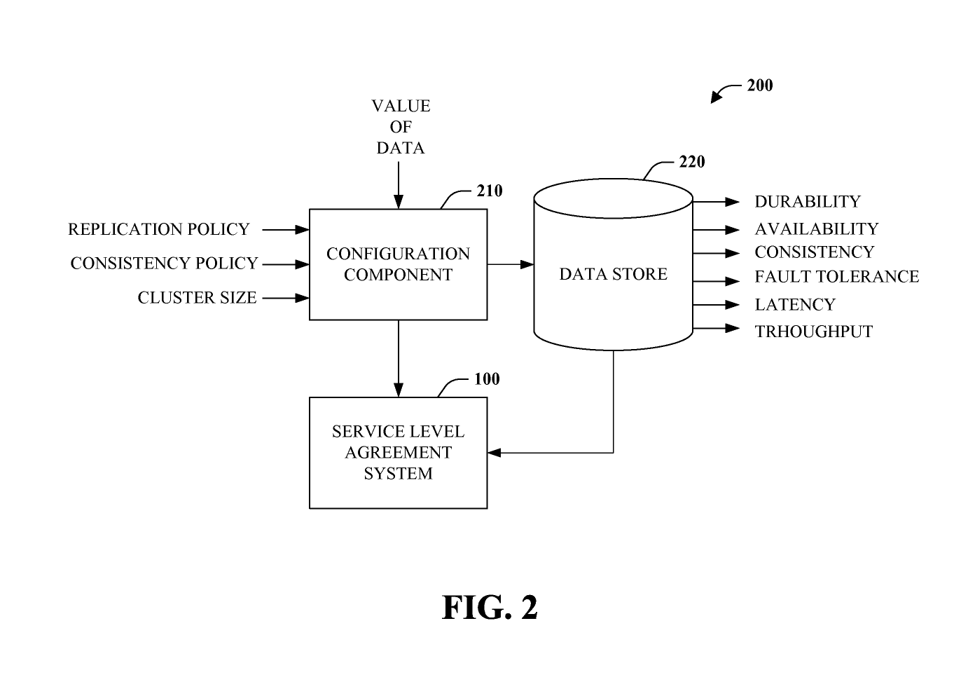

FIG. 2 depicts an exemplary data storage system 200 including the service-level-agreement system 100. The data storage system 200 can be a web, or cloud, based service in one embodiment and subject to an SLA. In one instance, the data storage system 200 is embodied as a distributed document-oriented storage system. Of course, aspects of the disclosed subject matter are not intended to be limited to document-oriented stores but rather are applicable to substantially any data store including any other type of non-relational or NoSQL store. Further, there is more particular applicability to purpose built stores, which are stores built for a specific purpose, access pattern, or workload, for example.

The data storage system 200 includes configuration component 210 that enables initial configuration of the data store 220 for a particular use. The configuration component 210 can receive, retrieve, or otherwise obtain or acquire configuration information regarding a workload. As previously noted, a workload can be specified in terms of a replica set, write quorum, read quorum, consistency level, and cluster size. Here, however, those factors can be further condensed to replication policy, consistency policy, and a cluster size specified by an application developer, for instance. The replication policy (a.k.a. availability policy) specifies the availability of the data store over a range of failures and includes the replica set and identification of synchronous or asynchronous replication. The consistency policy specifies at least a consistency level. The cluster size (a.k.a. scale factor) is indicative of the number of physical or virtual machines for use with respect to provisioning data store 220.

The data store 220, or an instance thereof, can be provisioned, or constructed, as a function of the inputs to the configuration component 210, here the replication policy, consistency policy, and cluster size. The data store 220 that results has various properties including durability, availability, consistency, fault tolerance, latency, and throughput. Accordingly, various configurations can result in initial configuration of different data stores. Additionally, it is to be appreciated that although illustrated as a single data store for simplicity, the data store 220 can be arbitrarily simple or complex based on the how it is configured.

In accordance with one embodiment, a logical partition can be used as a unit of redundancy and availability. Data within each logical partition is replicated for availability and reliability. Multiple copies of data corresponding to each logical partition can exist across compute nodes inside a cluster, and the multiple copies are maintained by virtue of the process of replication. The number of copies and the mechanisms of replicating the data of each partition can be governed by policies configurable by a developer at the time of provisioning an instance of a data store 220.

The data store 220 can provide the illusion of a single logical partition to a client. Internally, however, multiple copies of the state of a partition can be maintained across physical nodes to ensure the data is not lost in the face of failures. Clients can perform read and write requests against a partition, which is served by a replica. Multiple replicas, each serving operations from clients and managing its own local copy of the state of the logical partition, collectively implement a distributed, deterministic state machine. The replicated state machine is collectively implemented by a set of replicas, which constitutes the replica set of a logical partition.

There are at least three approaches to implement a replicated state machine protocol. First, write requests can be set to all replicas simultaneously, and the replicas agree on the ordering of operations based on an agreement protocol. Second, write requests can be set to an agreed upon/distinguished location called the primary. This is called single master or primary copy replication. Here, the primary propagates operations to other replicas, called secondaries, either synchronously, if the primary waits for propagation to safely commit on the secondaries before completing a client request or asynchronously, if the primary eagerly completes the client request without waiting on the outcome of replication. Regardless of synchronous or asynchronous modes, a primary can choose to wait for the acknowledgement of from all secondaries or a quorum of secondaries before considering replication successful. The third approach is the write requests are sent to an arbitrary location first. This approach allows for greater degree of write availability at the cost of complexity and depending on the implementation, a potential loss of consistency.

For the sake of brevity and clarity, discussion herein focusses on use of the second approach. However, the scope of the invention is not intended to be limited in scope to this approach. Regardless of implementation, the replicated state machine protocol is designed so that a client perceives to send both read and write operations to a single logical entity. The client remains oblivious to the replica failures, primary/master election, load balancing of replicas and other such concerns pertaining to replication and distribution.

In accordance with one embodiment, there exists a distinguished replica for a given logical partition, called the primary, which is replica capable of receiving and processing write requests (e.g., POST, PUT, PATCH, DELETE) which can create or mutate a resource from a client's perspective. Other replicas in the group are referred to as secondaries. The primary can perform operational replication in that it replicates each write operation issued by a client to other cohorts in the replica set. The primary performs both synchronous as well as asynchronous replication depending on the configuration and desired consistency level and uses a quorum based protocol for both write and read operations. Despite failures, a primary will exist for a given logical partition. Moreover, the primary coordinates replication of a client's write operations to secondaries. The state machine protocol can include both forward progress as well as catch-up of a replica, which could be lagging behind due to network conditions, previously failed, or newly introduced. Read requests from a client (e.g., GET, HEAD . . . ) can go to any replica inside a replica set. More specifically, a read request can go to any of a plurality of secondaries or the primary rather than merely targeting the primary.

While state machine replication provides the illusion of a logical entity for clients in the face of failures, intrinsic are tradeoffs around data availability, consistency, latency, and fault tolerance. Data availability is a complex function of individual node availability, the replication model, rate and distribution of correlated node failures, replica placement, and replica recovery times. Likewise, data consistency is a complex function of the guarantees provided by the replication mode and the exact model and mechanism of implementing write and read quorums. Latency is also a complex function of the mechanics of replication and the consistency model. Fault tolerance is dependent at least upon the cluster size and replica set.

The replication policy (a.k.a. availability policy) allows specification of a replica set. Since nodes can join or leave in the face of failures or administrative operations (e.g., updates, upgrades), the replica set can be a dynamic entity. In other words, membership of a replica set can change over time. The number of replicas constituting the replica set at a given point in time is denoted “N.”

At the time of provisioning a new instance of a data store, the developer can set the maximum replica set size, “N_{Max},” of the replica set by way of the replication policy. For a given partition (where multiple network partitions are employed), the value of “N” in steady state would be equal to “N_{Max}.” During periods when or more replicas are down, the value of “N” would be less than “N_{Max}.” Failed replicas can be brought back automatically and the value of “N” will climb back to “NMax.”

The choice of the value of “N_{Max}” is significant in deciding tradeoffs between availability, write latency, compute and bandwidth costs, and throughput. A higher value of “N_{Max}” implies higher fault tolerance and availability (write and read), data durability, and better read throughput. Choice of a large value of “N_{Max}” ensures that the data store can cope with a large number of simultaneous failures without losing availability and maintaining durability. However, the large value of “N_{Max}” comes at a cost of high write latency (due to higher value of write quorum) and an increase in storage, compute, and bandwidth costs. The rationale behind selecting a larger value of “N_{Max}” is the insurance for remaining available in the event of failures. The subject system allows developers to tradeoff high latency and storage cost in steady state to remain available in periods when the store is struck by simultaneous failures. Although not limited thereto, in general “N_{Max}” can be configured based on the following rule:

N_{Max}=2f+1, for odd values of N_{Max}, and,

N_{Max}=2f, for even values of N_{Max}.

Here, “f” is the number of simultaneous failures that are desired to be tolerated when “N=N_{Max}”.

The lower bound on membership size of a replica set is called minimum replica set size and is denoted by “N_{Min}.” It represents the lower bound on the durability and availability of write operations of the partition and thus the store as a whole. If the replica set “N” is less than “N_{Min},” the writes are blocked on the primary and the partition is considered unavailable for writes. The writes remain blocked until one or more of the failed replicas can recover and rejoin the replica set such that the replica set is restored to at least “N_{Min}.” The value of “N” can fluctuate between the extremes “N_{Max}” and “N_{Min}.” depending on the mean time to failure (MTTF). The rate at which the store reaches from “N_{Max}” to “N_{Min}” depends on the rate and number of failures versus the regeneration time for the failed replicas (e.g., MTTF (Mean Time To Failure) versus MTTR (Mean Time To Regeneration)).

In a Read-One-Write-All (ROWA) based replication model, the primary considers a client's write request successful only after it has durably committed to all of the replicas in the replica set. In contrast, in a quorum based replication model, the primary considers the write operation successful if it is durably committed by a subset called the write quorum (W) of replicas. Similarly, for a read operation, the client contacts the subset of replicas, called the read quorum (R) to determine the correct version of the resource; the exact size of read quorum depends on the consistency policy.

The fact that not all the replicas have to be contacted for writes or reads provides a significant performance boost. Further, a masking quorum based replication schemes, such described herein, provide data availability at the expected consistency level in the face of simultaneous and/or successive failures. Moreover, the masking scheme provided herein is dynamic in nature. Depending on rate of failures and the regeneration of failed replicas, the membership of the replica set is in flux. Since the write and read quorum values are calculated based the current size of the replica set and consistency level, these are both dynamic as well.

A quorum of replicas required to acknowledge a write replication operation before the request is acknowledged to the client by the primary is called the write quorum, denoted “W.” The write quorum thus acts as a synchronization barrier for the writes to become visible to the clients. Note that for efficiency, the primary may batch multiple write operations together into a single replication payload and propagate to the secondaries.

The write quorum used in the replication model as employed by the subject system can be a majority quorum. That is, the value of the write quorum is dynamically calculated as follows:

W=_{Ceiling}((N+1)/2)

Note that since the replica set “N” is dynamic and can range between “N_{Max}” and N_{Min},” the write quorum can be calculated dynamically and can range anywhere between “W_{Max}=_{Ceiling}(N_{Max}+1)/2)” and W_{Min}=_{Ceiling} (N_{Min}+1)/2)” at any point in time. The following table illustrates a set of values of write quorum based on the value of the number of replicas within a replica set at a given point in time.

TABLE 1

| Replica set (N) | Write quorum (W) |
|---|---|
| 1 | 1 |
| 2 | 2 |
| 3 | 2 |
| 4 | 3 |
| 5 | 3 |
| 6 | 4 |
| 7 | 4 |
| 8 | 5 |
| 9 | 5 |

In a static quorum based system where the value of “W” is fixed, once the number of replicas in a replica set reaches a point where “W” cannot be satisfied, the system becomes unavailable. The value of “W” in a static quorum based system thus acts as a digital switch for the availability. The moment the value of “N” falls below “W,” the system becomes unavailable. By contrast, here, the write quorum can be continuously self-adjusted dynamically corresponding to changes in membership (N) of the replica set. The value of “W” is adjusted dynamically corresponding to the value of “N” at any point in time. The self-adjusting model of dynamically calculating the write quorum enables a wider range of continued availability of the service while maintaining the desired level of consistency.

Note that “W”=1″implies asynchronous replication. Since the vote of the primary is sufficient for write to be considered successful, the client request need not be blocked for the replication (and write operation) to be considered successful. By contrast, “W>1” implies synchronous replication. Since more than the primary's vote is required for the write to be considered successful, the client request is blocked until the primary receives acknowledgement from “W−1” secondaries.

The dynamic, majority based write quorum is advantageous for providing both write availability without necessarily having to trade off support for a specified level of consistency. The write quorum can be automatically adjusted in the face of failures (changing values of “N”) until the write quorum reaches the “W_{Min}” corresponding to “N=N_{Min}.” This is the point at which the partition becomes unavailable for writes.

The quorum of replicas, denoted “R,” specifies the number or replicas that are required to be contacted to get the latest value of a resource for a given consistency level. Contacting the primary should be avoided except for particular circumstances. Just like the write quorum, the read quorum is also calculated dynamically based on a desired consistency level and the value of the write quorum and the replica set at a given point in time.

Latency of read operations is influenced by the value of “R.” In general, the larger the value of “R,” the longer it will take to complete a client read operation request. This also affects the throughput of read operations.

Similar to the write quorum, the value of the read quorum at any time can range between lower and upper bounds, which in this case are influenced by the desired consistency level specified by a developer at a cluster level. “R=1” is typical for eventually consistent reads and “R=N+1−W” for strongly consistent reads. Thus, the read and write quorums overlap. The following table illustrates various values of “R” corresponding to different values of “N” and “W” and consistency levels as will be described further hereinafter.

TABLE 2

| | | | Read Quorum | |
|---|---|---|---|---|
| | | | (R) for | |
| | | | Consistent | Read |
| | Write | Read Quorum | Prefix and | Quorum (R) |
| | Quorum | (R) for Strong | Session | for Eventual |
| Replica Set (N) | (W) | Consistency | Consistency | Consistency |
| 1 | 1 | 1 | 1 | 1 |
| 2 | 2 | 1 | 1 | 1 |
| 3 | 2 | 2 | 1 | 1 |
| 4 | 3 | 2 | 1 | 1 |
| 5 | 3 | 3 | 2 | 1 |
| 6 | 4 | 3 | 2 | 1 |
| 7 | 4 | 4 | 3 | 1 |

As mentioned, at the time of provisioning an instance of a data store, a developer can configure a replication policy. The replication policy describes read and write availability of the store in the face of configurable number of simultaneous failures. Read and write availability can by defined by specifying either “NMax” and “NMin” or the number of simultaneous failures the system can tolerate for reads and writes respectively. That is “N_{Max}−“N_{Min}” for reads and writes respectively. Based on the value of “N” at any given time, the write quorum and the read quorum can be dynamically computed.

The following is an exemplary class definition for an replication policy:

public sealed class ReplicationPolicy {

public ReplicationPolicy(int minReplicaSetSize = 2, int

maxReplicaSetSize = 3);

public int MinReplicaSetSize { get; }
public int MaxReplicaSetSize { get; }
public int IsSynchronous { get; } }

}

This policy describes read and write availability in light of a configurable number of simultaneous failures defined by specifying “N_{Max}” and “N_{Min}.” Further, note that replication can be either synchronous or asynchronous. Replication is synchronous if the primary waits for propagation to commit safely on the secondaries before completing a client request. Alternatively, replication is asynchronous or if the primary eagerly completes the client request without waiting on the outcome of replication.

Many disciplines of computer science including distributed systems, hardware, operating systems/runtimes, databases, and user groupware have each had rich formalisms for the consistency models and what data consistency means in the specific context. As an example, hardware engineers have defined memory models and cache coherence protocols with formal definitions of consistency levels. Although very similar on the surface, consistency levels differ in nuances and semantics from the ones that distributed systems engineers have defined for various distributed systems.

Conventional distributed storage systems lack a formal framework for reasoning about consistency. As examples, strong consistency means different things to different stores, and developers are forced to try to determine how eventual eventual consistency is in a particular store.

Further, each conventional storage system has defined its own nomenclature and interpretation of the consistency that it provides. Consequently, application developers are forced to understand specific nuances of consistency that a storage system provides. Worse yet, developers are forced to rationalize the nuanced semantics of data consistency exposed by two stores with the same names (e.g., eventual) but implying a different level of guarantees (e.g., read your writes consistency vs. consistent prefix).

To address this problem, formal definitions of consistency are provided. Although not limited thereto, four consistency levels and be utilized in decreasing order of consistency: strong, consistent prefix, session, and eventual. Developers can chose one of these four consistency levels as the consistency level for all read operations at the time of provisioning a store, for example. Alternatively, these levels can be specified on a per request basis.

Strong consistency is defined in terms of sequential or “one copy serializability” specification. Strong consistency guarantees that a write is only visible after it is committed durably by the write quorum of replicas. The conditions for strong consistency are thus: “W+R>N” and “W>N/2.”

The first condition ensures that the read and write quorums overlap. Any read quorum therefor is guaranteed to have the current version of the data. During network partitions, this condition also ensures that an item cannot be read in one partition and written in another—thus eliminating read-write conflicts.

The second condition ensures that the write quorum is the majority quorum. As previously noted, this can indeed be the case regardless of the consistency level. Further, given use of dynamic majority-based write quorums, the condition for strong consistency is: “R>N−_{Ceiling}((N+1)/2).”

Consistent prefix, session, and eventual consistency are three shades of weak consistency. The condition for these three forms of consistency is thus: “R+W<=N.” For use of dynamic quorums, the condition for the weaker forms of consistency is: “R<=N−_{Ceiling}((N+1)/2).”

Consistent prefix consistency allows reads to lag behind the writes (generally speaking with by some staleness), but clients are guaranteed to see the fresher values over time. Consistent prefix guarantees that clients can assume total order of propagation of updates without any gaps. By way of example, and not limitation, consider a thirty-millisecond delay in reads. In this case, reads are stale, but will not go back in time. Accordingly, if a value five was written at time one and then value six was written at time two, a read will acquire five and later six but not six and then five. Consistent prefix reads can be configured as “W+R<=N.”

Unlike the global consistency models offered by strong and consistent prefix, session level consistency is tailored for a specific client session. Session level consistency is usually sufficient since it provides all of the four guarantees that a client can expect. By default, configuring a store with consistency level equal to session automatically enables four well-known flavors of session consistency, namely read your writes, monotonic reads, writes follow read, and monotonic writes. Session level consistency can be configured as “R+W<=N,” where “W>=R.”

Eventual consistency is a global consistency level and it is the weakest form of consistency, wherein a client may get values that are older than ones previously acquired. In the previous example, a client might see six before five, five before six, or five for a period of time and then six. Eventual level consistency can be configured as “W+R<=N,” with a typical value of “R=1.” Any value of “R” greater than one is unnecessary since reading from any single replica would satisfy eventual consistency guarantees.

The following table captures the conditions for the four levels of consistency.

TABLE 3

| Consistency Level | Condition(s) |
|---|---|
| Strong | R + W > N |
| Consistent Prefix | R + W <= N |
| Session | R + W <= N and W >= R |
| Eventual | R + W <= N and R = 1 |

Staleness is a measure of anti-entropy propagation lag. Staleness can be described either in terms of a time interval or in terms of a number of write operations by which the secondaries are lagging behind the primary. When the consistency level is set to eventual, in theory the staleness of the system does not have any guaranteed upper bound. In practice though, most of the time a data store configured with consistency level of eventual provides up-to-date reads. In contrast, when the consistency level is set to strong, the staleness is said to be zero. When the level is set to consistent prefix, the staleness can be bounded between the extreme of strong and eventual, and can be configured by a developer at the cluster level.

The consistency policy describes the desired consistency level for read operations as well as bounded staleness. The following is an exemplary class definition for consistency level:

public enum ConsistencyLevel { Strong, ConsistentPrefix, Session,
Eventual
}
public sealed class BoundedStaleness {

public int MaxPrefix { get; set; }
public int MaxTimeIntervalInSeconds { get; set; }

}
public sealed class ConsistencyPolicy {

public ConsistencyLevel DefaultConsistencyLevel { get; set; }
public BoundedStaleness BoundedStaleness { get; }

}

As long as the write quorum is maintained, the write availability is guaranteed. The number of simultaneous failures that the replica set can tolerate can be calculated as “f=N−Rₒ,” where “Rₒ” is (the value of an internally maintained read quorum and is) defined as, “R_{o-Floor}((N+1)/2).”

The following table illustrates the number of simultaneous failures that the system can tolerate, its fault tolerance, corresponding to various values of “N” and “Rₒ.” The table also shows the corresponding values of “W.”

TABLE 4

| | | | Number of |
|---|---|---|---|
| | | | simultaneous |
| Replica | | Majority | failures that are |
| Set Size | Majority Write | Read | tolerated |
| (N) | Quorum (W) | Quorum (Rₒ) | f = N − Rₒ |
| 1 | 1 | 1 | 0 |
| 2 | 2 | 1 | 1 |
| 3 | 2 | 2 | 1 |
| 4 | 3 | 2 | 2 |
| 5 | 3 | 3 | 2 |
| 6 | 4 | 3 | 3 |
| 7 | 4 | 4 | 3 |
| 8 | 5 | 4 | 4 |
| 9 | 5 | 5 | 4 |

As seen from Table 4, for a given replica set configuration, the value of “W” holds until a set of simultaneous or successive failures occur causing the value of “N” to drop and eventually become equal to “Rₒ.” At that point, the value of “W” is re-adjusted as the majority quorum of the current value of “N.”

In the worst case, assuming that the MTTF remains significantly less than MTTR, “W” and “N” both which drop to their minimum values and the system will become unavailable until one or more replicas can recover. The write quorum can be adjusted again in synchronization with the growing replica set size.

When the number of simultaneous failures exceed “N−Rₒ,” the quorum is considered to be lost. The situation with quorum loss is identical to that when the value of “N” reaches “N_{Min}.” At this point, the system waits for a configurable amount of time for one or more failed replicas to recover. If the replicas fail to recover during that period, new replicas can automatically be created and introduced to the replica set. Subsequently, new replicas catch-up from the cohorts and build their state.

Dynamic quorums are more resilient to faults both simultaneous as well as, successive compared to their static quorum counterparts. An asynchronous consensus algorithm with static quorum can tolerate “f=(N−1)/2” simultaneous fail stop faults. To appreciate the failure model associated with the static quorums, consider a replica set of size “N=5” and static write quorum “W=3.” The number of simultaneous failures the system can tolerate is two. After two simultaneous failures, the value of “N” has reached three. At this point, any additional failures will force the write quorum to go below three, causing the service to become unavailable. Notice that even though there are three full replicas alive, which can tolerate one additional failure, the system has become unavailable because the write quorum was statically configured to be three.

Contrast this with a dynamic quorum based system. For “N_{Max}=5” and “N_{Min}=2,” in steady state “N=N_{Max}=5.” Two simultaneous failures would lead to “N=3” and “W=2.” Notice the value of “W” has been lowered to be the majority of the current replica set. In fact, the system is capable of tolerating up to three total failures before reaching “W_{Min}” and subsequently becoming unavailable for writes. In general, the dynamic majority based quorum allows for tolerating “N−N_{Min}” numbers of successive failures.

The durability of the write operations is subject to the value of write quorum (W). As long as the write quorum is maintained at a value greater than the number of simultaneous failures, the write operation is will survive and the system avoids any data loss within the cluster. The minimum value of “W” to tolerate a minimum number of “f” simultaneous failures is “W_{Min}=f_{Min}+1.”

Note that while running on commodity hardware where data center outages/disasters are always an unfortunate possibility, intra-cluster durability is not sufficient. To that end, “W>f,” is not sufficient for avoiding data center outages. To cope with data center disasters, an incremental backup of the data inside logical partitions can be performed in the background.

Further, a developer can selectively mark collections of data as sealed, indicating the collection is read-only from that point onwards. Sealed collections can be configured to be erasure coded to improve the durability and fault tolerance (for a comparable storage cost of required in case of full replication), along with significant savings in storage cost but at the cost of reduction in read performance.

The configurable consistency model applies to the replicated state machine comprising a group of replicas. This forms a global or distributed view of data consistency across a set of replicas. At each replica site, the local view of data consistency across a set of read and write operations can be atomic, strongly consistent, isolates individual operations from side effects, and is durable. In other words, the replica is ACID compliant.

In accordance with the CAP theorem, a decision has to be made between reducing consistency (C) or availability (A) when there is a network partition (P). In other words, the CAP theorem forces storage system designers to answer the following question: “If there is a partition, does the system give up availability or consistency?”

Based on the CAP theorem, there are three types of distributed systems:
AP—Always available and partition tolerant but inconsistent;
CP—Consistent and partition tolerant but unavailable during partitions; and
CA—Consistent and available but not tolerant of partition.
   In practice, “A” and “C” are asymmetrical and thus reducing the three types into essentially two: CP/CA and AP. Stated differently, it is possible to build a system that is consistent in the face of partitions or available, but not both. Note the CAP theorem imposes no restriction in the baseline and steady state of the system where there are no network partitions. In the absence of network partitions, the system can continue to provide both strong and sequential consistency without making any compromises.

The CAP theory, however, does not capture latency. Depending on the system, stronger levels of consistency usually come at the cost of higher latencies.

A variant of CAP, called PACELC, adds that in absence of a partition, a decision has to be made between reducing latency or consistency. More specifically, PACELC states that if there is a partition (P) the system has to make a tradeoff between availability (A) and consistency (C) else (E) in the absence of network partitions the system has to tradeoff between latency (L) and consistency (C). Typically, systems that tend to give up consistency for availability when there is a partition also tend to give up consistency for latency when there is no partition. The exact tradeoffs are dependent on a specific application workload in terms of its requirement for availability, latency, and consistency. However, instead of baking these tradeoffs into a storage system, a storage system can be configured to make correct tradeoffs. This can be done by configuring the availability and consistency policies.

The tradeoff between consistency and latency pointed out by PACELC is applicable to the subject storage system. However, unlike static quorum based systems where higher levels of consistency correspond to higher read and write latencies, by using a dynamic quorum based approach, there is a strong correlation between consistency and read latency but not write latency. More specifically, the “L” in PACELC corresponds to read operations only. The latency of write operations remains the same regardless of the level of consistency. The “ELC” part of PACELC also assumes that latency and availability are strongly correlated. However, this is based on a static quorum based system, as is discussed further below. Use of a dynamic write and read quorums avoids the strong correlation of latency and availability as well as consistency and availability.

Latency of write operations directly corresponds to higher values of “W.” Stated differently, the higher the value of “W,” the worse the write latency gets. Note also that the dynamic nature of the write quorum implies that for a given consistency level, the write latencies fluctuate based on the value of “N.” Due to the use of dynamic write quorums, the latency of the write operations is closely related to the value of “N” at a given point of time, and is largely independent of the consistency level. As shown in Table 3, higher values of “N” imply higher values of “W.” In a steady state when “N=N_{Max},” higher values of “N_{Max}” will correspond to a higher value of “W” and vice versa. During failures when “N<N_{Max},” or for low values of “N_{Max},” “W” is adjusted and is relatively of a lower value. This implies that so long as “N” is smaller (either in steady state or amidst failures), “W” is smaller leading to better write latencies.

Latency of read operations directly corresponds to higher values of “R.” In other words, the higher the value of “R,” the worse the read latency gets. The dynamic nature of read quorum implies that that for a given consistency level, the read latencies fluctuate based on the value of “N.” Due to the use of dynamic read quorums, the latency of the read operations is closely related to the value of “N” at a given point in time, as well as the consistency level. This is different from the relationship of write latency and consistency level in which write latencies where independent of the consistency level.

The condition for strong consistency is “R>N−_{Ceiling}((N+1)/2).” Thus, strongly consistent read for higher values of “N” necessitate higher values of “R” resulting in higher read latencies. Conversely, for weaker forms of consistency, a relatively low value of “R” (e.g., one or two) is sufficient resulting in lower read latency. This results because the condition for weaker forms of consistency is “R<=N−_{Ceiling}((N+1)/2).” These observations are also evident from Table 3 for various values of “N,” “W,” and “R.”

In most storage systems with statically configured write quorum, strong consistency implies higher (fixed) value of “W” relative to “N.” The availability of write operations degrades if the quorum cannot be satisfied due to replica failures. Such systems tend to give up consistency (so they can use a smaller W) or write availability in the face of failures.

By contrast, use of dynamic and majority based write quorums results in the value of “W” being constantly adjusted depending on the current replica set size “N.” This ensures that the availability of write operations is not compromised despite the replica failures (until the replica set reaches “N_{Min}”). The dynamic and self-tuning of write quorums allows for maintaining the desired consistency guarantees without having to sacrifice the write availability as long as “N” remains between “N_{Max}” and “N_{Min}”.

Again, use of dynamic and majority based read quorums results in the value of “R” being constantly adjusted depending on the current replica set size “N,” the current write quorum “W,” and the desired consistency level (which ultimately decides if “R>N−W” or “R<=N−W”). This ensures that the availability of read operations is not compromised despite replica failures (until the replica set reduces to a single replica). The dynamic and self-tuning of read quorums allows for maintain the desired consistency guarantees without having to sacrifice read availability for as long as a single replica remains alive.

In static quorum bases systems that use a fixed value of “W,” the write availability and latencies are directly correlated. Higher values of “W” correspond to deterioration in write availability and latency. This is because the primary has to wait until a fixed number of “W−1” replicas can respond before sending the response to the client. The availability of the write operation suffers if any of the replicas among the quorum of “W−1” replicas are slow to respond or if the quorum cannot be satisfied due to failures. Stated differently, a high latency would imply unavailability of the system.

In a dynamic quorum based approach, however, the value of “W” is automatically self-adjusted based on the current replica set. Hence, the availability of write operations is not gated by the current value of “W” but the latency is gated by the current value of “W.” The availability of write operations is gated by the fact that the write quorum needs to be met. Thus, in order to be available for writes, the replica set “N” should be between “N_{Min}” and “N_{Max}.”

Again, in static quorum based systems that use a fixed value of “R,” the read availability and latencies are directly correlated. Higher values of “R” correspond to deterioration in read availability and latency. This is because for the read operation to be successful, the client needs to wait until a fixed number of “R” replicas respond (where “R>N−W” or “R<=N−W,” depending on the level of consistency expected by the client). The availability of the read operation suffers if any of the replicas among the quorum of “R” replicas are slow to respond or if the quorum cannot be satisfied due to failures. Stated differently, a high latency implies unavailability of the system.

However, in the dynamic quorum based approach, the value of “R” is automatically self-adjusted based on the current replica set, write quorum, and the consistency level. Hence, the availability of a read operation is not gated by the current value of “R” as is the case with latency.

Although the configuration component 210 is illustrated as accepting availability and consistency policies, the subject invention is no so limited. For example, the configuration component can accept direct specification of initial values of “N,” “W,” “R,” and consistency level directly. As dynamic values, they can subsequently be adjusted in response to changes at runtime.

Rather than driving generation of the data store 220 from availability and consistency policies, for example, the value of data can be utilized. In accordance with one embodiment, a value of data can be mapped it to particular policies or specific values (e.g., “N,” “W,” “R”) accepted by the configuration component 210, if not natively supported by the configuration component 210.

Here, value of data means valuation of data. For example, data can be classified as high value, medium value, and low value. Data can be considered high value if its durability and consistency are crucial. Most ACID (e.g., atomicity, consistency, isolation, durability) databases, which guarantee database transactions are processed reliability as transactions, are geared toward high value data and thus tend to tradeoff availability for consistency in the face of partitions and otherwise tradeoff latency for consistency. On the other hand, if data is low value, availability and latency are crucial at the cost of durability and consistency. Of course, there is a wide range of application workloads that fall between high and low value and they are termed medium value. In the face of partitions, availability can be traded for consistency and otherwise consistency can be traded for latency for medium value data. Thus, high value data can be mapped to strong level consistency, medium value data can be mapped to consistent prefix or session level consistency, and low value data can be mapped to eventual level consistency. The following table summarizes the above information and provides additional information about how the nature of data can drive configuration and ultimately the nature of the resulting store.

TABLE 5

| | | | | | Read |
|---|---|---|---|---|---|
| How | | | | Write Latency, | Latency |
| valuable is | Consistency | | | Availability, | and |
| data? | Level | N_{Max} | N_{Min} | and Durability | Availability |
| High Value | Strong | 5 | 2 | High | High |
| Medium | Consistent | 3 | 2 | Medium | Medium |
| Value | Prefix or | | | | |
| | Session | | | | |
| Low Value | Eventual | 2 | 1 | Low | Low |

Simultaneous failures can happen if nodes share power supplies, switches, cooling units, or racks. To ensure that a given partition remains available during scheduled upgrades and simultaneous node failures, each of the replicas within the replica set can be placed in separate upgrade and fault domains.

The SLA system 100 can utilize configuration information acquired by the configuration component 210 enable generation of an SLA. Relationships exist between a cluster size, replica set “N,” write quorum “W,” read quorum “R,” and consistency level, among others that enable guarantees to be determined for durability, availability, consistency, fault tolerance, latency, and throughput. By way of example, and not limitation, the cluster size impacts read and write throughput, the replica set affects fault tolerance and availability, the write quorum impacts write latency, the read quorum affects read latency, and the consistency level impacts read throughput and latency. Accordingly, the guarantees can be generated for availability, consistency, latency, and fault tolerance, among others based on a configuration. In some instance, the guarantees can be specified in terms of upper and/or lower bounds. For example, if “N” is allowed to vary between “N_{Max}” and “N_{Min},” bounded guarantees can be utilized. Specification of value of data provides three predefined configurations high, medium, and low. Workload configuration utilizing policies as described with respect to system 200 or finer grain “knobs” (e.g., “N,” “W,” “R” . . . ) enables configurations between high, medium, and low. In either event, guarantees can be computed or simply identified if pre-computed, and from these guarantees, an SLA can be generated.

Furthermore, the SLA system 100 can receive input regarding the operation of the data store 220 to enable monitoring. As previously described, monitoring can be employed to allow a comparison between actual service level and that guaranteed by the SLA, the result of which can be provided as real-time feedback to a client and utilized for invoice generation purposes.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, the SLA system 100 can utilize such mechanism to infer guarantees and/or aid generation of an SLA.

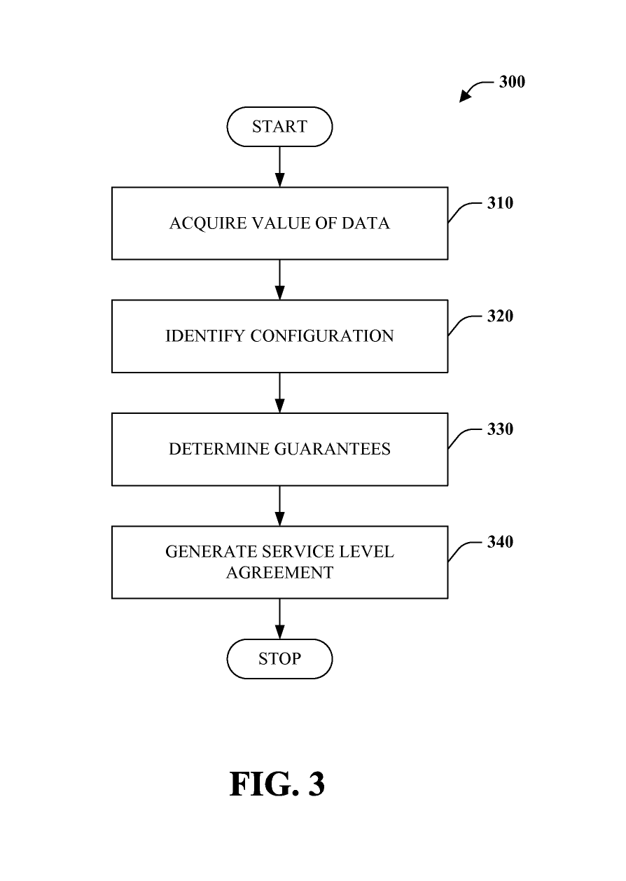

In view of the exemplary systems described supra, methodologies that may be implemented in accordance with the disclosed subject matter will be better appreciated with reference to the flow charts of FIGS. 3-5. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 3, a method of service level agreement generation based on data value is illustrated. A reference numeral 310, a value of data is received, retrieved or otherwise obtained or acquired. The value of data can be one of high, medium, and low value. Accordingly, the value pertains to the nature of the data as opposed to a specific value for a data type. As examples, enterprise mission-critical data can be classified as high value, and location data associated with a location-based social networking application can be low value. Medium value data can be data that is between mission critical and relatively insignificant data.

At reference numeral 320, a configuration is identified that is associated with the value of data acquired. For instance, a high value data configuration can include strong consistency and a replication set value of five, among other things. Alternatively, a low value configuration can include eventual consistency and a replication set of two.

Guarantees are determined at numeral 330 based on the identified configuration. For instance, a high value data configuration a guarantee will include strong consistency with or without partitioning at the cost of availability and latency respectively. For a low value data configuration guarantees of high availability in the face of partitions and low latency absent partitions at the cost of consistency and availability, respectively. This are of course simply general guarantees for illustrative purposes. More detail guarantees are likely when a complete configuration is taken into account.

Additionally, staleness can be taken into account. For example, in a scenario involving a primary replica and a secondary replica it can be determined that the secondary lags behind the primary for some period of time or number of operations. This staleness metric capturing the lag can also be utilized as a data point when generating one or more guarantees.

Furthermore, data value configurations can be preset. In other words, the configuration can be known in advance and unlikely to change. Accordingly, the guarantees may at least be partially pre-computed in advance. As a result, upon acquiring the value of data it may not be necessary to first identify the configuration. Instead, the method can just move to identifying the guarantees for the identified value of data.

At reference numeral 340, a service level agreement is generated based on the guarantees. In accordance with one embodiment, the entire SLA can be generated automatically. Alternatively, the SLA can be generated semi-automatically based on human input. Of course, it is also possible to provide the guarantees to a human for manual construction of the SLA.

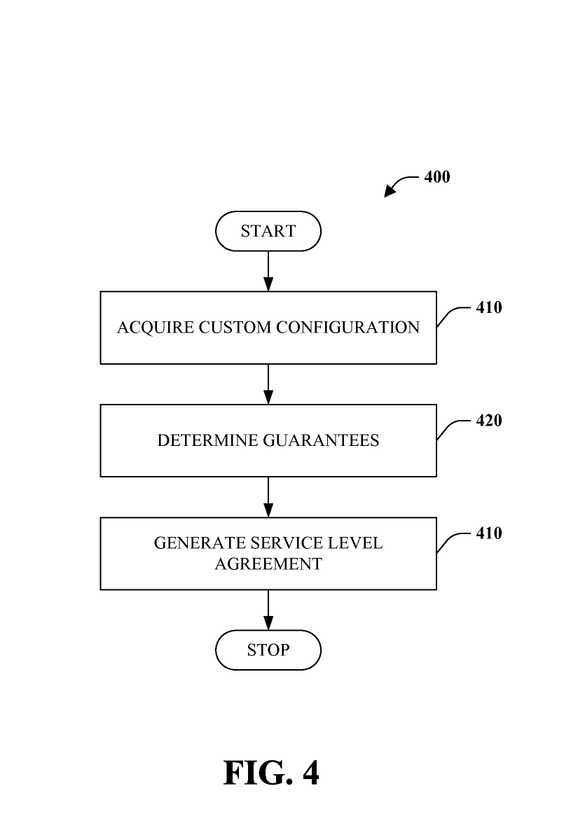

FIG. 4 depicts a method of service level agreement generation based on a workload 400. At reference numeral 410, a custom configuration is acquired. In one instance, the configuration is specified in terms of replica set “N,” write quorum “W,” read quorum “R,” consistency level, and cluster size. Alternatively, the configuration can be specified in terms of a replication policy including a replica set “N,” a consistency policy including a consistency level and staleness bound or metric, and cluster size. These are just exemplary forms of configuration of a plurality of possibilities. Further, it should be noted that the configuration can include conditional configuration parameters such as but not limited to a ranking of desired consistency levels.

At reference numeral 420, guarantees can be determined from the configuration. There are relationships between configuration parameters such as replica set, write quorum, read quorum, and consistency level that govern availability, consistency, latency, and durability for example. Accordingly, determining guarantees can involve performing a computation based on input configuration to produce output guarantees.

In some cases, the guarantees can be bounded either or both of high and low. For example, in dynamic quorum systems such system 200 that includes range of replicas, and dynamically computed read and write quorums guarantee bound may be used. Further, in situations where specific information is not specified that would affect guarantees such as the presence or absence of network partitions, guarantees can be provided in the alternative to reflect both cases.

Additionally, staleness can be taken into account. For example, in scenario involving a primary replica and a secondary replica it can be determined that the secondary lags behind the primary for some period of time or number of operations. This staleness metric can also be utilized as a data point when generating one or more guarantees.

A service level agreement is generated at numeral 430. In one embodiment, the SLA can be generated automatically without human intervention. Alternatively, generation can be semi-automatic automatic based in part on human intervention. For example, portions can be automatically generated and/or suggestion provided. Of course, the SLA could be manually generated as well based on provided guarantees.

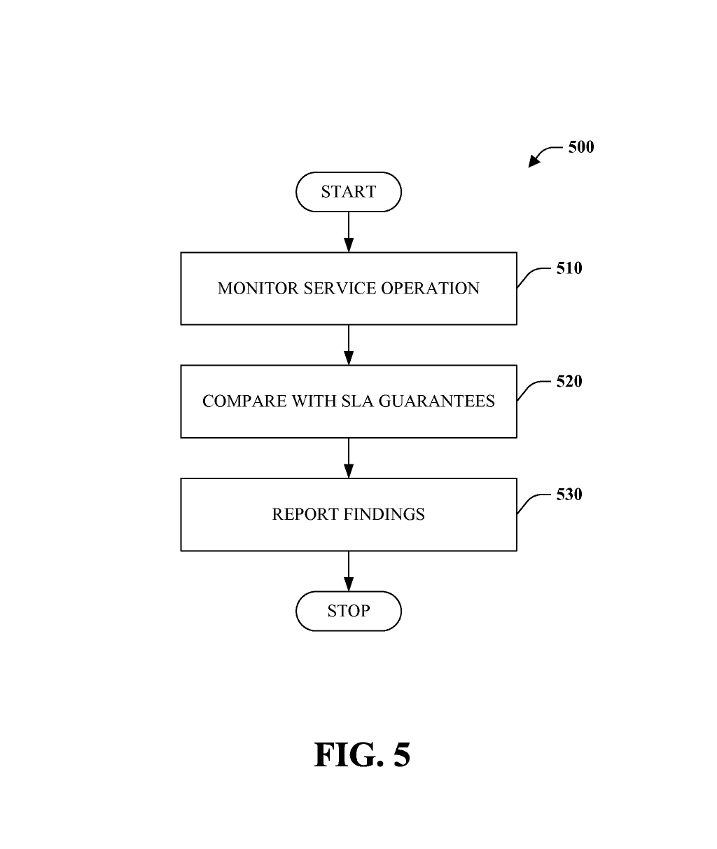

FIG. 5 is a flow chart diagram of a method of service operation monitoring 500. At reference numeral 510, the operation of a service is monitored. By way of example, and not limitation, each transaction with the system can be monitored to determine characteristics pertinent to guarantees. At numeral 520, a comparison can be made between actual operation and guarantees made. Findings of the comparison can be reported at reference numeral 530. In accordance with one embodiment, the findings can be provided as real time or substantially real time feedback to a client, for instance by way of a dashboard interface. In this manner, prompt adjustments can be made where desired based on performance with respect to conditional guarantees and/or guarantee violations. Additionally or alternatively, such findings can be utilized to with respect to invoice generation so as not charge or alternative to credit a client where there is a guarantee failure.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the terms “component,” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

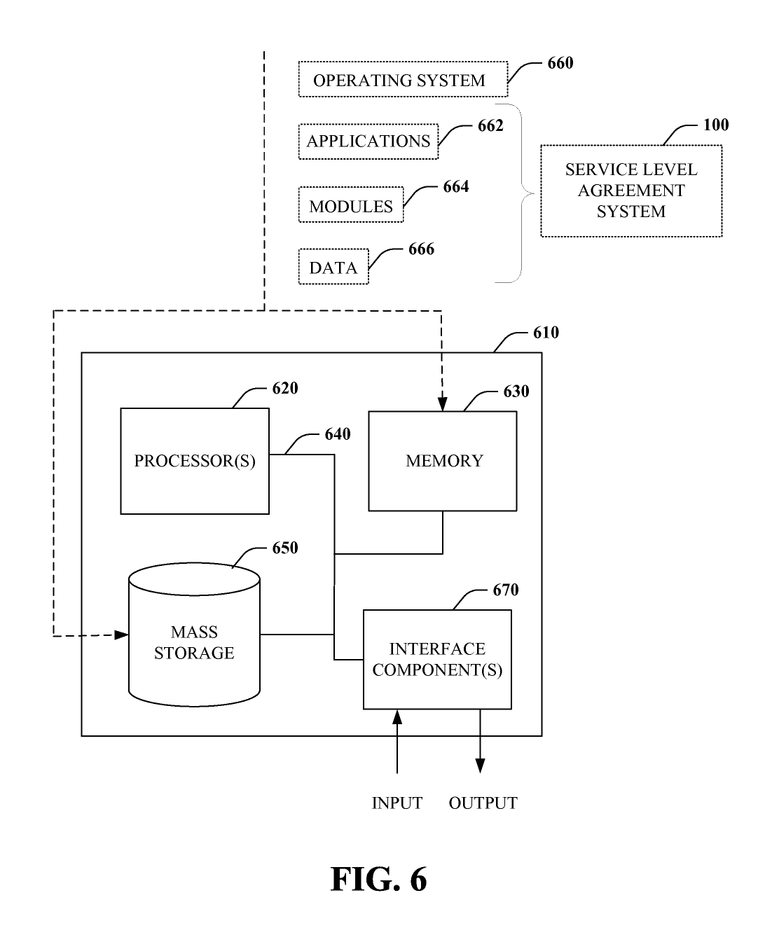

In order to provide a context for the claimed subject matter, FIG. 6 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 6, illustrated is an example general-purpose computer 610 or computing device (e.g., desktop, laptop, tablet, server, hand-held, programmable consumer or industrial electronics, set-top box, game system . . . ). The computer 610 includes one or more processor(s) 620, memory 630, system bus 640, mass storage 650, and one or more interface components 670. The system bus 640 communicatively couples at least the above system components. However, it is to be appreciated that in its simplest form the computer 610 can include one or more processors 620 coupled to memory 630 that execute various computer executable actions, instructions, and or components stored in memory 630.

The processor(s) 620 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 620 may also be implemented as a combination of computing devices, for example a combination of a DSP and a microprocessor, a plurality of microprocessors, multi-core processors, one or more microprocessors in conjunction with a DSP core, or any other such configuration.

The computer 610 can include or otherwise interact with a variety of computer-readable media to facilitate control of the computer 610 to implement one or more aspects of the claimed subject matter. The computer-readable media can be any available media that can be accessed by the computer 610 and includes volatile and nonvolatile media, and removable and non-removable media. Computer-readable media can comprise computer storage media and communication media.

Computer storage media includes volatile and nonvolatile, removable and non-removable media implemented in any method or technology for storage of information such as computer-readable instructions, data structures, program modules, or other data. Computer storage media includes memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums which can be used to store the desired information and which can be accessed by the computer 610. Furthermore, computer storage media excludes signals.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 630 and mass storage 650 are examples of computer-readable storage media. Depending on the exact configuration and type of computing device, memory 630 may be volatile (e.g., RAM), non-volatile (e.g., ROM, flash memory . . . ) or some combination of the two. By way of example, the basic input/output system (BIOS), including basic routines to transfer information between elements within the computer 610, such as during start-up, can be stored in nonvolatile memory, while volatile memory can act as external cache memory to facilitate processing by the processor(s) 620, among other things.

Mass storage 650 includes removable/non-removable, volatile/non-volatile computer storage media for storage of large amounts of data relative to the memory 630. For example, mass storage 650 includes, but is not limited to, one or more devices such as a magnetic or optical disk drive, floppy disk drive, flash memory, solid-state drive, or memory stick.

Memory 630 and mass storage 650 can include, or have stored therein, operating system 660, one or more applications 662, one or more program modules 664, and data 666. The operating system 660 acts to control and allocate resources of the computer 610. Applications 662 include one or both of system and application software and can exploit management of resources by the operating system 660 through program modules 664 and data 666 stored in memory 630 and/or mass storage 650 to perform one or more actions. Accordingly, applications 662 can turn a general-purpose computer 610 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the service level agreement system 100, or portions thereof, can be, or form part, of an application 662, and include one or more modules 664 and data 666 stored in memory and/or mass storage 650 whose functionality can be realized when executed by one or more processor(s) 620.

In accordance with one particular embodiment, the processor(s) 620 can correspond to a system on a chip (SOC) or like architecture including, or in other words integrating, both hardware and software on a single integrated circuit substrate. Here, the processor(s) 620 can include one or more processors as well as memory at least similar to processor(s) 620 and memory 630, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the service-level-agreement system 100 and/or associated functionality can be embedded within hardware in a SOC architecture.

The computer 610 also includes one or more interface components 670 that are communicatively coupled to the system bus 640 and facilitate interaction with the computer 610. By way of example, the interface component 670 can be a port (e.g., serial, parallel, PCMCIA, USB, FireWire . . . ) or an interface card (e.g., sound, video . . . ) or the like. In one example implementation, the interface component 670 can be embodied as a user input/output interface to enable a user to enter commands and information into the computer 610, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 670 can be embodied as an output peripheral interface to supply output to displays (e.g., CRT, LCD, plasma . . . ), speakers, printers, and/or other computers, among other things. Still further yet, the interface component 670 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method, comprising:
employing at least one processor configured to execute computer-executable instructions stored in a memory to perform the following acts:
generating a service level agreement comprising at least one of consistency, availability, latency, or fault tolerance guarantees based on a configuration of a distributed data store

2. The method of claim 1, generating the service level agreement based on a configuration specified in terms of a value classification of data.

3. The method of claim 2 further comprises:
identifying a configuration for a particular value of data; and
generating the at least one of consistency, availability, latency, or fault tolerance guarantees as a function of the configuration.

4. The method of claim 3, identifying a configuration including strong consistency for high value data.

5. The method of claim 3, identifying a configuration including consistent prefix or session consistency for medium value data.

6. The method of claim 3, identifying a configuration including eventual consistency for low value data.

7. The method of claim 1, generating the service level agreement based on a configuration specified in terms of a replica set, consistency level, and a cluster size.

8. The method of claim 1 further comprising providing real time feedback comparing operation of a service to the service level agreement.

9. A system, comprising:
a processor coupled to a memory, the processor configured to execute the following computer-executable components stored in the memory:
a first component configured to determine one or more guarantees based on a distributed data store configuration specified in terms of a data value classification; and
a second component configured to generate a service level agreement for the data store including the one or more guarantees.

10. The system of claim 9, the first component is configured to determine the one or more guarantees as a function of strong level consistency for high value data.

11. The system of claim 9, the first component is configured to determine the one or more guarantees as a function of consistent prefix or session level consistency for medium value data.

12. The system of claim 9, the first component is configured to determine the one or more guarantees as a function of eventual level consistency for low value data.

13. The system of claim 9, the first component is configured to determine the one or more guarantees as a function of a staleness metric.

14. The system of claim 9 further comprises a third component configured to provide real time feedback regarding satisfaction and violation of the one or more guarantees during service operation.

15. The system of claim 9 further comprises a third component configured to invoice a client based on a pricing model associated with the service level agreement.

16. A computer-readable storage medium having instructions stored thereon that enable at least one processor to perform a method upon execution of the instructions, the method comprising:
generating a service level agreement for a distributed storage system including guarantees pertaining to one or more of availability, consistency, latency, or fault tolerance as a function of a storage system configuration comprising at least a replica set and a consistency level.

17. The method of claim 16 further comprises mapping a classification of data value to a configuration comprising the at least a replica set and a consistency level.

18. The method of claim 16 further comprises generating the service level agreement with at least one conditional guarantee.

19. The method of claim 16 further comprises providing real-time feedback regarding satisfaction or violation of the guarantees during interaction with the storage system.

20. The method of claim 16 further comprising generating an invoice that accounts for a violation of one or more of the guarantees.
